(19) United States
(12) Patent Application Publication
(10) Pub. No.: US 2025/0294109 A1
(43) Pub. Date: Sep. 18, 2025

(54) IMAGE FORMING DEVICE, CONTROL METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Akihiko SATOMI, Shiojiri (JP)

(21) Appl. No.: 19/074,509

(22) Filed: Mar. 10, 2025

(30) Foreign Application Priority Data
Mar. 12, 2024 (JP) 2024-037842

(51) Int. Cl. H04N 1/44; H04N 1/00

(52) U.S. Cl. CPC H04N 1/4413; H04N 1/00244; H04N 1/00795; H04N 2201/0094

(57) ABSTRACT

A multifunction peripheral coupled to a mail server includes: a reading unit that reads a document; a user authentication unit that executes user authentication according to an SMTP authentication method or a PIN authentication method; an electronic mail transmission unit that transmits, to the mail server, an electronic mail to which information read by the reading unit is attached; and an electronic mail setting unit that sets a transmission source mail address of the electronic mail according to an authentication method when the user authentication unit executes the user authentication.

The present application is based on, and claims priority from JP Application Serial Number 2024-037842, filed Mar. 12, 2024, the disclosure of which is hereby incorporated by reference herein in its entirety.

### BACKGROUND

### 1. Technical Field

The present disclosure relates to an image forming device, a control method, and a non-transitory computer-readable storage medium storing a program.

### 2. Related Art

JP-A-2023-137927 discloses a multifunction peripheral having a function, that is, a so-called Scan to Mail function of converting scan data of a document into electronic data such as PDF, attaching the converted electronic data to an electronic mail, and transmitting the electronic mail. Specifically, when a transmission destination mail address of the electronic mail to which the electronic data is attached is set, the electronic mail is previously transmitted to the multifunction peripheral. The multifunction peripheral extracts the transmission destination mail address from the received electronic mail.

When authentication information used for SMTP authentication does not match a mail address set in a From header of the electronic mail, some mail servers reject the electronic mail. Accordingly, there is a case where the Scan to Mail function cannot be used, and convenience is reduced.

### SUMMARY

Provided is an image forming device coupled to a mail server including:
a reading unit configured to read a document;
a user authentication unit configured to execute user authentication according to a first authentication method or a second authentication method;
a mail transmission unit configured to transmit, to the mail server, an electronic mail to which information read by the reading unit is attached; and
a transmission source mail address setting unit configured to set a transmission source mail address of the electronic mail according to an authentication method when the user authentication unit executes the user authentication.

Provided is a method of controlling an image forming device coupled to a mail server, the method including:
by the image forming device
   reading a document;
   executing user authentication according to a first authentication method or a second authentication method;
   transmitting, to the mail server, an electronic mail to which read information is attached; and
   setting a transmission source mail address of the electronic mail according to an authentication method when the user authentication is executed.

Provided is a non-transitory computer-readable storage medium storing a program, the program causing an image forming device coupled to a mail server to function as:
a reading unit configured to read a document;
a user authentication unit configured to execute user authentication according to a first authentication method or a second authentication method;
a mail transmission unit configured to transmit, to the mail server, an electronic mail to which information read by the reading unit is attached; and
a transmission source mail address setting unit configured to set a transmission source mail address of the electronic mail according to an authentication method when the user authentication unit executes the user authentication.

### BRIEF DESCRIPTION OF THE DRAWINGS

FIG. 1 is a schematic diagram of a mail system.

FIG. 2 is a block diagram of a multifunction peripheral.

FIG. 3 is a data structure diagram of an SMTP authentication list.

FIG. 4 is a data structure diagram of a PIN authentication list.

FIG. 5 is a data structure diagram of device information.

FIG. 6 is a control flow of the multifunction peripheral.

### DESCRIPTION OF EMBODIMENTS

Hereinafter, the disclosure will be described through an embodiment of the disclosure, but the disclosure according to the claims is not limited to the following embodiment. All of configurations described in the embodiment are not necessarily essential as means for solving the problem. To clarify the description, omissions and simplifications have been made as appropriate in the description and the drawings below. In the drawings, the same elements have the same reference numerals, and no duplicated description of the same elements is made as required.

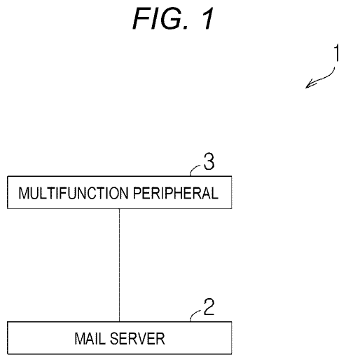

FIG. 1 shows a schematic diagram of a mail system 1. As shown in FIG. 1, the mail system 1 includes a mail server 2 and a multifunction peripheral 3. The mail server 2 and the multifunction peripheral 3 are typically configured to perform two-way communication via a wide area network (WAN).

The mail server 2 is a simple mail transfer protocol (SMTP) server. That is, the mail server 2 is an electronic mail transmission server that transmits, to a transmission destination mail address set in a To header, an electronic mail received from the multifunction peripheral 3. The mail server 2 may be constructed integrally with an electronic mail reception server such as a post office protocol (POP) server or an internet message access protocol (IMAP) server. In the embodiment, the mail server 2 is a mail server corresponding to authenticated SMTP (SMTP-AUTH). That is, when communication is performed from the multifunction peripheral 3 to the mail server 2, the mail server 2 requests the multifunction peripheral 3 for SMTP authentication information, and performs the SMTP authentication based on the SMTP authentication information.

The multifunction peripheral 3 is a specific example of an image processing device. The multifunction peripheral 3 is a specific example of an image forming device. The multifunction peripheral 3 has a printing function of printing print data on a sheet that is a print medium, a reading function of reading a document and generating the read information, a copying function of copying the document, and other functions. The multifunction peripheral 3 further has a so-called Scan to Mail function of attaching the read information generated by the reading function to an electronic mail and transmitting the electronic mail via the mail server 2. Here, the read information is typically electronic data in a file format of a portable document format (PDF). In the embodiment, the multifunction peripheral 3 has a so-called access restriction function of requesting a user to perform user authentication when the user uses the multifunction peripheral 3.

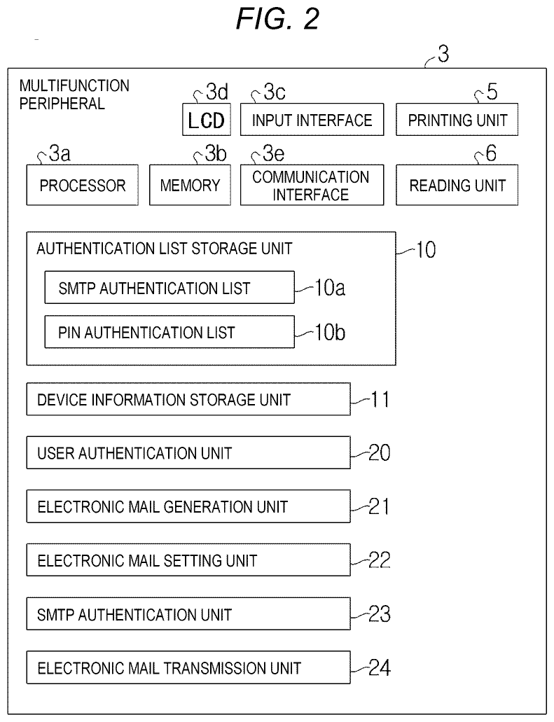

FIG. 2 shows a block diagram of the multifunction peripheral 3. As shown in FIG. 2, the multifunction peripheral 3 includes a processor 3a, a memory 3b, an input interface 3c, a liquid crystal display (LCD) 3d, and a communication interface 3e. The multifunction peripheral 3 communicates with the mail server 2 via the communication interface 3e. The processor 3a can access the memory 3b. The processor 3a reads and executes a program stored in the memory 3b. Accordingly, the program causes hardware such as the processor 3a to function as a user authentication unit 20, an electronic mail generation unit 21, an electronic mail setting unit 22, an SMTP authentication unit 23, and an electronic mail transmission unit 24. The memory 3b constitutes an authentication list storage unit 10 and a device information storage unit 11. The multifunction peripheral 3 further includes a printing unit 5 corresponding to the above-described printing function and a reading unit 6 corresponding to the above-described reading function. The printing unit 5 and the reading unit 6 cooperate to implement the above-described copying function.

The memory 3b is typically implemented by a read only memory (ROM), a random access memory (RAM), a hard disc drive (HDD), or a solid state drive (SSD).

The input interface 3c is a unit for receiving an operation performed by the user. The input interface 3c is typically implemented by a touch panel.

The LCD 3d is a unit for displaying visual information. The multifunction peripheral 3 may include an organic light emitting diode (OLED) instead of the LCD 3d.

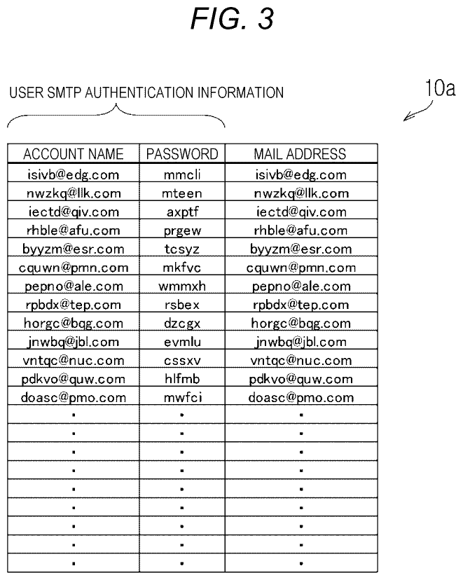

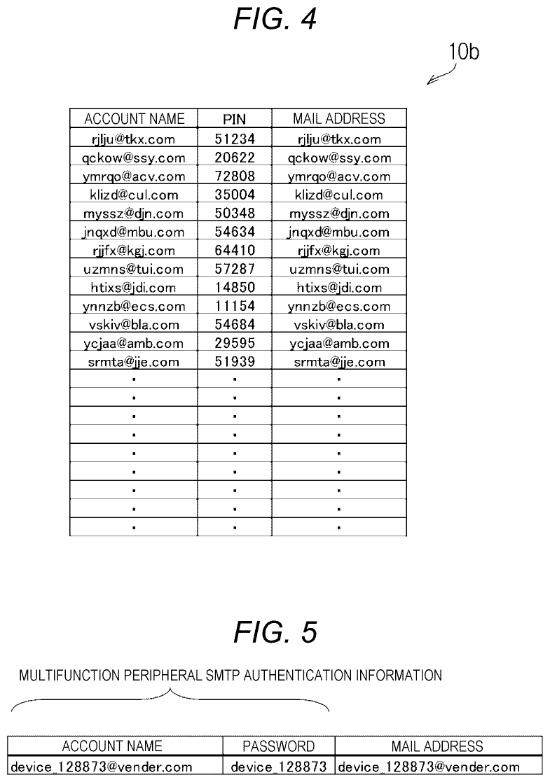

The authentication list storage unit 10 includes an SMTP authentication list 10a and a PIN authentication list 10b for authentication determination of the user authentication. The SMTP authentication list 10a is a specific example of a first list. The PIN authentication list 10b is a specific example of a second list. FIG. 3 shows a data structure diagram of the SMTP authentication list 10a. FIG. 4 shows a data structure diagram of the PIN authentication list 10b.

As shown in FIG. 3, the SMTP authentication list 10a is a list in which an account name, a password, and a mail address unique to a user are associated with one another for each user. In FIG. 3, the “account name unique to the user” means an account name assigned to each user. The “password unique to the user” is a password set by the user in association with the account name. The “mail address unique to the user” means a mail address assigned to each user. As shown in FIG. 3, typically, the account name unique to the user aligns with the mail address unique to the user. The account name unique to the user and the password unique to the user constitute user SMTP authentication information which is SMTP authentication information unique to the user. The user SMTP authentication information can be used for SMTP authentication in the mail server 2.

As shown in FIG. 4, the PIN authentication list 10b is a list in which an account a personal identification number (PIN), and a mail address unique to a user are associated with one another for each user. In FIG. 4, the “account name unique to the user” means an account name assigned to each user. The “PIN unique to the user” means a personal identification number for identifying the user. The personal identification number is also simply referred to as a personal identification number. The “mail address unique to the user” means a mail address assigned to each user.

In the embodiment, the authentication list storage unit 10 stores the SMTP authentication list 10a shown in FIG. 3 and the PIN authentication list 10b shown in FIG. 4 as separate lists. Alternatively, the authentication list storage unit 10 may store the SMTP authentication list 10a and the PIN authentication list 10b in one list in a mixed state.

The device information storage unit 11 stores device information. FIG. 5 shows a data structure diagram of the device information. As shown in FIG. 5, the device information includes an account name, a password, and a mail address unique to the multifunction peripheral 3. In FIG. 5, the “account name unique to the multifunction peripheral 3” means an account name assigned to the multifunction peripheral 3. The “password unique to the multifunction peripheral 3” is a password set by an administrator of the multifunction peripheral 3 in association with the account name of the multifunction peripheral 3. The “mail address unique to the multifunction peripheral 3” means a mail address assigned to the multifunction peripheral 3. As shown in FIG. 5, typically, the account name unique to the multifunction peripheral 3 aligns with the mail address unique to the multifunction peripheral 3. The account name unique to the multifunction peripheral 3 and the password unique to the multifunction peripheral 3 constitute multifunction peripheral SMTP authentication information which is SMTP authentication information unique to the multifunction peripheral 3. The multifunction peripheral SMTP authentication information is a specific example of device SMTP authentication information. The multifunction peripheral SMTP authentication information can be used for SMTP authentication in the mail server 2.

The user authentication unit 20 supports an SMTP authentication method for performing user authentication by inputting the user SMTP authentication information and a PIN authentication method for performing user authentication by inputting a PIN. That is, the user authentication unit 20 performs the user authentication according to either the SMTP authentication method or the PIN authentication method selected by the user. That is, the user can perform the user authentication by inputting the user SMTP authentication information to the multifunction peripheral 3, or can perform the user authentication by inputting the PIN to the multifunction peripheral 3.

Specifically, the user authentication unit 20 can simultaneously display, on the LCD 3d of the multifunction peripheral 3, a user SMTP authentication information input screen for inputting user SMTP authentication information and a PIN screen for inputting the PIN.

When the user inputs the user SMTP authentication information on the user SMTP authentication information input screen, the user authentication unit 20 performs the user authentication according to the SMTP authentication method. In this case, specifically, the user authentication unit 20 refers to the SMTP authentication list 10a in FIG. 3, and determines that the user authentication is successful when user SMTP authentication information aligning with the user SMTP authentication information input by the user is included in the SMTP authentication list 10a. On the other hand, the user authentication unit 20 refers to the SMTP authentication list 10a, and rejects subsequent operations when user SMTP authentication information aligning with the user SMTP authentication information input by the user is not included in the SMTP authentication list 10a.

When the user inputs the PIN on the PIN input screen, the user authentication unit 20 performs the user authentication according to the PIN authentication method. In this case, specifically, the user authentication unit 20 refers to the PIN authentication list 10b in FIG. 4, and determines that the user authentication is successful when a PIN aligning with the PIN input by the user is included in the PIN authentication list 10b. On the other hand, the user authentication unit 20 refers to the PIN authentication list 10b, and rejects subsequent operations when a PIN aligning with the PIN input by the user is not included in the PIN authentication list 10b.

The electronic mail generation unit 21 generates an electronic mail to which electronic data in a PDF file format generated by the reading unit 6 reading a document is attached. Here, “generating the electronic mail” can be said to generate an electronic mail transmission job.

The electronic mail setting unit 22 sets a header of the electronic mail generated by the electronic mail generation unit 21. The header of the electronic mail typically includes a To header, a From header, and a Subject header. The electronic mail setting unit 22 is a specific example of a From header setting unit. The electronic mail setting unit 22 is a specific example of a transmission source mail address setting unit.

The electronic mail setting unit 22 sets a To header. Specifically, the electronic mail setting unit 22 displays a transmission destination mail address setting screen for inputting or selecting a transmission destination mail address on the LCD 3d. The electronic mail setting unit 22 acquires the transmission destination mail address input or selected by the user on the transmission destination mail address setting screen. The electronic mail setting unit 22 sets the acquired transmission destination mail address in the To header of the electronic mail.

The electronic mail setting unit 22 sets a From header. Specifically, the electronic mail setting unit 22 sets the From header according to the authentication method when the user authentication unit 20 executes the user authentication.

That is, when the user authentication unit 20 executes the user authentication according to the SMTP authentication method, the electronic mail setting unit 22 refers to the SMTP authentication list 10a shown in FIG. 3 and sets a mail address unique to the user in the From header. On the other hand, when the user authentication unit 20 executes the user authentication according to the PIN authentication method, the electronic mail setting unit 22 refers to the device information shown in FIG. 5 and sets a mail address unique to the multifunction peripheral 3 in the From header.

The SMTP authentication unit 23 performs SMTP authentication on the mail server 2. Specifically, the SMTP authentication unit 23 performs the SMTP authentication on the mail server 2 according to the authentication method used when the user authentication unit 20 executes the user authentication.

That is, when the user authentication unit 20 executes the user authentication according to the SMTP authentication method, the SMTP authentication unit 23 performs the SMTP authentication on the mail server 2 using the user SMTP authentication information. On the other hand, when the user authentication unit 20 executes the user authentication according to the PIN authentication method, the SMTP authentication unit 23 performs the SMTP authentication on the mail server 2 using the multifunction peripheral SMTP authentication information.

After the SMTP authentication in the mail server 2 is successful, the electronic mail transmission unit 24 transmits the electronic mail to the mail server 2. That is, the electronic mail transmission unit 24 transmits a header, a main text, and attached electronic data of the electronic mail to the mail server 2.

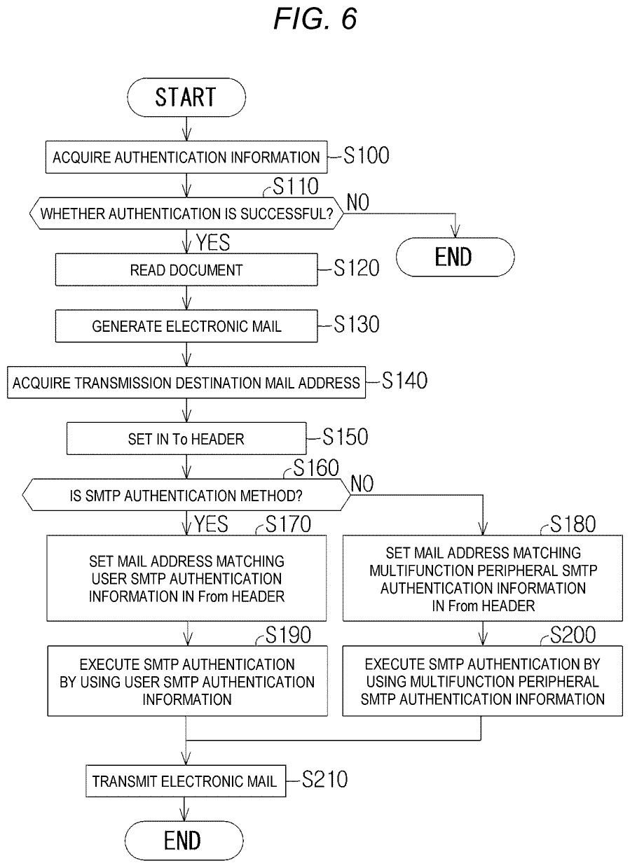

Next, an operation flow of the multifunction peripheral 3 will be described with reference to FIG. 6. Hereinafter, it is assumed that a user A transmits a document to a user B using the Scan to Mail function of the multifunction peripheral 3.

### S100

First, the user authentication unit 20 simultaneously displays, on the LCD 3d of the multifunction peripheral 3, the user SMTP authentication information input screen for inputting the user SMTP authentication information and the PIN input screen for inputting the PIN. In response to this, the user A inputs the user SMTP authentication information on the user SMTP authentication information input screen or inputs the PIN on the PIN input screen. Accordingly, the user authentication unit 20 acquires authentication information necessary for the user authentication.

### S110

Next, the user authentication unit 20 determines whether the user authentication is successful based on the authentication information input by the user A. At this time, as described above, when the user A inputs the user SMTP authentication information on the user SMTP authentication information input screen, the user authentication unit 20 performs the user authentication according to the SMTP authentication method. On the other hand, when the user A inputs the PIN on the PIN input screen, the user authentication unit 20 performs the user authentication according to the PIN authentication method. When the user authentication unit 20 determines that the user authentication is successful (S110: YES), the user authentication unit 20 advances the processing to step S120. On the other hand, when the user authentication unit 20 determines that the user authentication fails (S110: NO), the user authentication unit 20 rejects subsequent operations and ends the processing.

### S120

Next, the reading unit 6 reads a document set by the user A and generates electronic data in a PDF file format as read information.

### S130

Next, the electronic mail generation unit 21 generates an electronic mail to which the electronic data generated by the reading unit 6 is attached.

### S140

Next, the electronic mail setting unit 22 acquires the transmission destination mail address by displaying the transmission destination mail address setting screen for inputting or selecting the transmission destination mail address on the LCD 3d.

### S150

Next, the electronic mail setting unit 22 sets the transmission destination mail address acquired in step S140 in the To header of the electronic mail generated by the electronic mail generation unit 21.

### S160 to S180

Next, the electronic mail setting unit 22 sets a From header. Specifically, when the user authentication unit 20 executes the user authentication according to the SMTP authentication method (S160: YES), the electronic mail setting unit 22 refers to the SMTP authentication list 10a, sets the mail address unique to the user A in the From header (S170), and advances the processing to step S190. On the other hand, when the user authentication unit 20 executes the user authentication according to the PIN authentication method (S160: NO), the electronic mail setting unit 22 refers to the device information, sets the mail address unique to the multifunction peripheral 3 in the From header (S180), and advances the processing to step S200.

### S190 to S200

Next, the SMTP authentication unit 23 performs the SMTP authentication on the mail server 2. Specifically, when the user authentication unit 20 executes the user authentication according to the SMTP authentication method (S160: YES), the SMTP authentication unit 23 performs the SMTP authentication on the mail server 2 using the user SMTP authentication information (S190), and advances the processing to step S210. On the other hand, when the user authentication unit 20 executes the user authentication according to the PIN authentication method (S160: NO), the SMTP authentication unit 23 performs the SMTP authentication on the mail server 2 using the multifunction peripheral SMTP authentication information (S200), and advances the processing to step S210.

### S210

Next, after the SMTP authentication in the mail server 2 is successful (S190 and S200), the electronic mail transmission unit 24 transmits the electronic mail to the mail server 2.

Here, the reason why the user authentication unit 20 supports the PIN authentication method will be described. That is, a password required for the SMTP authentication when the multifunction peripheral 3 communicates with the mail server 2 is required to be periodically changed from the viewpoint of security. Therefore, in order to perform the user authentication using the user SMTP authentication information even after the password is (S110), the administrator of the multifunction peripheral 3 needs to update the SMTP authentication list 10a every time the password is changed. For example, when the SMTP authentication list 10a is formed by a list of 100 persons or 1000 persons, update of the SMTP authentication list 10a every time is an extremely large burden for the administrator of the multifunction peripheral 3. Therefore, the PIN authentication method that does not need to manage a password required for the SMTP authentication is additionally adopted. As shown in FIG. 4, the PIN authentication list 10b does not store a password originally required for the SMTP authentication. Therefore, even when the password required for the SMTP authentication is frequently changed, the administrator of the multifunction peripheral 3 is released from the trouble of updating the PIN authentication list 10b every time.

Next, step S180 and step S200 will be described in detail. As described above, in step S200, when the user authentication unit 20 executes the user authentication according to the PIN authentication method (S160: NO), the SMTP authentication unit 23 performs the SMTP authentication on the mail server 2 using the multifunction peripheral SMTP authentication information (S200). This is because the SMTP authentication unit 23 cannot acquire the SMTP authentication information corresponding to the input PIN in the case of the PIN authentication method (S160: NO). That is, as shown in FIG. 4, the password necessary for the SMTP authentication is not stored in the PIN authentication list 10b. Therefore, when the user authentication unit 20 executes the user authentication according to the PIN authentication method (S160: NO), it can be said that it is reasonable that the SMTP authentication unit 23 performs the SMTP authentication on the mail server 2 using the multifunction peripheral SMTP authentication information instead of the user SMTP authentication information (S200).

Here, when the user authentication unit 20 executes the user authentication according to the PIN authentication method (S160: NO), what kind of mail address is set in the From header by the electronic mail setting unit 22 becomes a problem. When the user A transmits a document to the user B using the Scan to Mail function of the multifunction peripheral 3, for the user B, it is convenient that the transmission source mail address of the electronic mail received by the user B suggests the user A. This is because when an electronic mail is received, a transmission source mail address of the electronic mail is confirmed from the viewpoint of security. As shown in FIG. 4, the PIN authentication list 10b associates a mail address corresponding to the PIN input by the user A with the PIN. Accordingly, from the viewpoint of the security described above, even when the user authentication unit 20 executes the user authentication according to the PIN authentication method (S160: NO), the electronic mail setting unit 22 naturally sets the mail address of the user A in the From header.

However, in this case, the electronic mail transmitted to the mail server 2 by the electronic mail transmission unit 24 may be rejected by the mail server 2. This is because, when the user authentication unit 20 executes the user authentication according to the PIN authentication method (S160: NO), the SMTP authentication unit 23 performs the SMTP authentication on the mail server 2 using the multifunction peripheral SMTP authentication information (S200), but the account name of the multifunction peripheral SMTP authentication information does not match the mail address of the user A set in the From header. Here, matching typically means alignment. When the account name during the SMTP authentication does not match the mail address set in the From header, the mail server 2 rejects the electronic mail in order to prevent a so-called spoofing mail.

Therefore, in the embodiment, as described above, when the user authentication unit 20 executes the user authentication according to the PIN authentication method (S160: NO), the electronic mail setting unit 22 refers to the device information and sets the mail address unique to the multifunction peripheral 3 in the From header (S180). According to this, since the transmission source mail address of the electronic mail received by the user B is set to an unknown mail address, the user B may fail to trust the electronic mail. However, by setting the mail address unique to the multifunction peripheral 3 in the From header (S180), it is possible to stably avoid a situation in which the electronic mail is originally rejected by the mail server 2 while sacrificing convenience for the user B. Accordingly, the Scan to Mail function of the multifunction peripheral 3 functions without any problem even in the PIN authentication method.

The preferred embodiment of the disclosure have been described above. The above embodiment has the following features.

The multifunction peripheral 3 (image forming device) coupled to the mail server 2 includes: the reading unit 6 that reads a document; the user authentication unit 20 that executes user authentication according to an SMTP authentication method (first authentication method) or a PIN authentication method (second authentication method); the electronic mail transmission unit 24 (mail transmission unit) that transmits, to the mail server 2, an electronic mail to which information read by the reading unit is attached; and the electronic mail setting unit 22 (transmission source mail address setting unit) that sets a transmission source mail address of the electronic mail according to an authentication method when the user authentication unit 20 executes the user authentication. According to the above configuration, it is possible to appropriately set the transmission source mail address of the electronic mail according to the authentication method when the user authentication unit 20 executes the user authentication.

The SMTP authentication method is an authentication method using an account name and a password unique to a user. When the user authentication unit 20 executes the user authentication according to the SMTP authentication method (S160: YES), the electronic mail setting unit 22 sets the mail address unique to the user as the transmission source mail address of the electronic mail (S170). According to the above configuration, when the user authentication unit 20 executes the user authentication according to the SMTP authentication method, it is possible to set the mail address unique to the user as the transmission source mail address of the electronic mail.

The PIN authentication method is an authentication method using a personal identification number (PIN) unique to the user. When the user authentication unit 20 executes the user authentication according to the PIN authentication method (S160: NO), the electronic mail setting unit 22 sets the mail address unique to the multifunction peripheral 3 as the transmission source mail address of the electronic mail (S180). According to the above configuration, when the user authentication unit 20 executes the user authentication according to the PIN authentication method, it is possible to set the mail address unique to the multifunction peripheral 3 as the transmission source mail address of the electronic mail.

The multifunction peripheral 3 further includes the SMTP authentication unit 23 that performs the SMTP authentication on the mail server 2. According to the above configuration, the mail server 2 requiring the SMTP authentication can be used.

When the user authentication unit 20 executes the user authentication according to the SMTP authentication method (S160: YES), the SMTP authentication unit 23 performs the SMTP authentication using the user SMTP authentication information (the SMTP authentication information unique to the user) (S190). When the user authentication unit 20 executes the user authentication according to the PIN authentication method (S160: NO), the SMTP authentication unit 23 performs the SMTP authentication using the multifunction peripheral SMTP authentication information (the SMTP authentication information unique to the multifunction peripheral 3) (S200). According to the above configuration, when the user authentication unit 20 executes the user authentication according to the PIN authentication method (S160: NO), the SMTP authentication can be performed (S200) without knowing the user SMTP authentication information.

Although the embodiment of the disclosure has been described above, the above embodiment can be modified as follows.

That is, in the above embodiment, the multifunction peripheral 3 includes the authentication list storage unit 10. Alternatively, a lightweight directory access protocol (LDAP) server as an external device may include the authentication list storage unit 10, and the multifunction peripheral 3 may access the LDAP server as appropriate to refer to the SMTP authentication list 10a or the PIN authentication list 10b.

### Appendix 1

An image processing device in which user authentication is required for use, the image processing device including:
a user authentication unit corresponding to an SMTP authentication method for the user performing authentication by inputting user SMTP authentication information, which includes an account name and a password and which is SMTP authentication information unique to a user, and a personal identification number authentication method for performing the user authentication by inputting a personal identification number unique to the user;
an electronic mail generation unit configured to generate an electronic mail to which electronic data generated by reading a document is attached;
a From header setting unit configured to set a From header of the electronic mail;
an SMTP authentication unit configured to perform SMTP authentication on an SMTP server; and
a mail transmission unit configured to transmit the electronic mail to the SMTP server, in which
when the user authentication unit performs the user authentication according to the SMTP authentication method, the From header setting unit sets a mail address that matches the user SMTP authentication information in the From header, and the SMTP authentication unit performs the SMTP authentication using the user SMTP authentication information, and
when the user authentication unit performs the user authentication according to the personal identification number authentication method, the From header setting unit sets, in the From header, a mail address that matches device SMTP authentication information which is SMTP authentication information unique to the image processing device and which includes an account name and a password, and the SMTP authentication unit performs the SMTP authentication using the device SMTP authentication information.

### Appendix 2

The image processing device according to Appendix 1, further including:
a list storage unit that stores
   a first list in which the account name, the password, and the mail address unique to the user are associated with one another, and
   a second list in which the personal identification number and the mail address unique to the user are associated with each other, in which
the user authentication unit refers to the first list when the user authentication is performed according to the SMTP authentication method, and refers to the second list when the user authentication is performed according to the personal identification number authentication method.

### Appendix 3

The image processing device according to Appendix 1, in which
a mail address set in the From header of the electronic mail by the From header setting unit is different from a mail address set in a To header of the electronic mail by the From header setting unit.

In the above example, the program can be stored using various types of non-transitory computer readable media and supplied to a computer. The non-transitory computer readable medium includes various types of tangible storage media. Examples of the non-transitory computer readable medium include a magnetic recording medium (for example, a flexible disk, a magnetic tape, or a hard disk drive) and a magneto-optical recording medium (for example, a magneto-optical disk). Examples of the non-transitory computer readable medium further include a read only memory (CD-ROM), a CD-R, a CD-R/W, and a semi-conductor memory (for example, a mask ROM). Examples of the non-transitory computer readable medium further include a programmable ROM (PROM), an erasable PROM (EPROM), a flash ROM, and a random access memory (RAM). The program may be supplied to the computer by various types of transitory computer readable media. Examples of the transitory computer readable medium include an electric signal, an optical signal, and an electromagnetic wave. The transitory computer readable medium can supply a program to the computer via a wired communication path such as an electric wire and an optical fiber or a wireless communication path.

What is claimed is:

1. An image forming device coupled to a mail server, comprising:
a reading unit configured to read a document;
a user authentication unit configured to execute user authentication according to a first authentication method or a second authentication method;
a mail transmission unit configured to transmit, to the mail server, an electronic mail to which information read by the reading unit is attached; and
a transmission source mail address setting unit configured to set a transmission source mail address of the electronic mail according to an authentication method when the user authentication unit executes the user authentication.

2. The image forming device according to claim 1, wherein
the first authentication method is an authentication method using an account name and a password unique to a user, and
when the user authentication unit executes the user authentication according to the first authentication method, the transmission source mail address setting unit sets a mail address unique to the user as the transmission source mail address of the electronic mail.

3. The image forming device according to claim 1, wherein
the second authentication method is an authentication method using a personal identification number unique to a user, and
when the user authentication unit executes the user authentication according to the second authentication method, the transmission source mail address setting unit sets a mail address unique to the image forming device as the transmission source mail address of the electronic mail.

4. The image forming device according to claim 1, further comprising:
an SMTP authentication unit configured to perform SMTP authentication on the mail server.

5. The image forming device according to claim 4, wherein
when the user authentication unit executes the user authentication according to the first authentication method, the SMTP authentication unit performs the SMTP authentication using SMTP authentication information unique to the user, and
when the user authentication unit executes the user authentication according to the second authentication method, the SMTP authentication unit performs the SMTP authentication using SMTP authentication information unique to the image forming device.

6. A method of controlling an image forming device coupled to a mail server, the method comprising:
by the image forming device
reading a document;
executing user authentication according to a first authentication method or a second authentication method;
transmitting, to the mail server, an electronic mail to which read information is attached; and
setting a transmission source mail address of the electronic mail according to an authentication method when the user authentication is executed.

7. A non-transitory computer-readable storage medium storing a program, the program causing an image forming device coupled to a mail server to function as:
a reading unit configured to read a document;
a user authentication unit configured to execute user authentication according to a first authentication method or a second authentication method;
a mail transmission unit configured to transmit, to the mail server, an electronic mail to which information read by the reading unit is attached; and
a transmission source mail address setting unit configured to set a transmission source mail address of the electronic mail according to an authentication method when the user authentication unit executes the user authentication.
